(19) United States
(12) Patent Application Publication
(10) Pub. No.: US 2016/0107572 A1
(43) Pub. Date: Apr. 21, 2016

(54) Methods and Apparatus for Integrated Forward Display of Rear-View Image and Navigation Information to Provide Enhanced Situational Awareness

(71) Applicant: Skully Helmets, Campbell, CA (US)

(72) Inventors: Marcus Daniel Weller, San Francisco, CA (US); Mitchell Ryan Weller, San Francisco, CA (US)

(21) Appl. No.: 14/519,091

(22) Filed: Oct. 20, 2014

(51) Int. Cl. B60R 1/00; H04N 5/232; G02B 27/01

(52) U.S. Cl. CPC B60R 1/00; G02B 27/0101; G02B 27/0172; G02B 27/0103; H04N 5/23238; B60R 1/001; G02B 2027/0138; G02B 2027/014; G02B 2027/0141; B60R 2300/10; B60R 2300/205; B60R 2300/207; B60R 2300/802; B60R 2300/302

(57) ABSTRACT

A situational awareness system is disclosed herein for providing heads-up display to a user on a moving vehicle. The display is focused at an ocular infinity in order to prevent accommodation lag in the user's comprehension. A super wide-angle (e.g., 170 degree to 210 degree) rear-view camera provides rearward looking video imagery to the user, which may be digitally processed and enhanced. Additional information is optionally provided in the display, including maps, turn by turn directions, and visual indicators guiding the user for forward travel. Additional information is optionally provided by audio. One embodiment comprises a full-face motorcycle helmet with a see-through micro-display that projects a virtual image in-line with the helmet-wearer's field of view. A second embodiment comprises a unit that projects a virtual image on a windshield in the operator's field of view.

### TECHNICAL FIELD

The present disclosure relates to a Heads-up Display (HUD), also referred to as Head Mounted Display (HMB) system and methods of using the same, which include a rear looking camera that provides a rear-view image that is integrated with vehicle navigation, which is presented to an operator on a heads up display viewable while the operator is facing the forward vehicle direction.

### BACKGROUND OF THE RELATED ART

In avionics, the benefits of a HUD in an airplane cockpit has been well explored—see “Heads-up display for pilots”, U.S. Pat. No. 3,337,845 by Gerald E. Hart, granted Aug. 22, 1967.

In the previously filed U.S. patent application Ser. No. 13/897,025, filed May 17, 2013, titled “Augmented Reality Motorcycle Helmet” published as US 2013/0305437, (which claims benefit of U.S. Provisional Patent Application Ser. No. 61/649,242) a display was projected on to the inner surface of a motorcycle helmet visor.

### SUMMARY

The HUD system described herein focuses, in one aspect, on improved safety via enhanced situational awareness. Advantageously, the HUD system directly enhances vehicle operator safety by providing increased situational awareness combined with decreased reaction time.

The HUD system may be part of a digitally-enhanced helmet in one embodiment. Other embodiments of the HUD system include, but are not limited to, a windshield of a motorized or human-powered vehicle for ground or water transportation.

Additionally, this HUD design incorporates: (1) turn-by-turn direction elements for forward travel; (2) vehicle telemetry and status information; (3) both combined with a rearward view of scene behind and to the sides of the operator on the display.

Additionally, this HUD design incorporates: (1) music (2) telephony (3) “walky-talky” auditory functionality, through (1.a) internal storage; (1.b) connection to a paired smart-phone device via BlueTooth or other radio or USB or other wired connection; (2.a) connection to a paired smart-phone device; (3.a) radio communication via BlueTooth or other radio to another device.

Additionally, this HUD design improves on user safety by utilizing a display combined with focusing lenses collimated so that the display will appear to be at an optical distance of infinity, which reduces user delay by eliminating the need for a user to re-focus their eye from the road surface ahead (“visual accommodation”).

In another aspect is provided an optical stack of display, lenses, and a partially reflective prism or holographic waveguide in a helmet which presents imagery focused at infinity, therefore negating the need for an operator's eye to change focal accommodation from road to display, thus decreasing reaction time.

Additionally the HUD display may be semi-transmissive (or “see-through”) so that the display imagery and information does not completely occlude the operators vision in the image frustum occupied by the display.

Additionally, the HUD design digitally processes the super-wide camera imagery to provide more accurate perceived distance perception of objects in the view by the operator.

Additionally, the HUD design presents audio information to the operator in the form of digitally generated voice or as sounds that function “earcons” corresponding to alerts.

Additionally, the HUD design presents haptic information to the operator in the form of a buzzer or pressure that functions as alerts.

### BRIEF DESCRIPTION OF THE DRAWINGS

The present disclosure will be better understood from a reading of the following detailed description, taken in conjunction with the accompanying drawing figures in which like references designate like elements, and in which:

FIG. 1 is a view of one embodiment incorporating features of the present disclosure, including a helmet with an integrated micro display and an integrated rear looking camera;

FIG. 2 is a view of one embodiment of a an integrated micro display with backlit L.E.D. micro display, collimating lenses, and a partially silvered prismatic cube to cause a right angle bend in the displayed image path;

FIG. 3 is a view of another embodiment of an integrated micro display with backlit L.E.D, micro display, collimating lenses, and a holographic waveguide to cause a 180 degree displayed (two right angle) image path;

FIG. 4 is a diagram of the system for video creation, flow and combination, and display according to a preferred embodiment.

FIG. 5 is a view of a 180 degree “fish-eye” camera image (left) and a view of a dewarped image (right) which has been transformed so as to accomplish equal angles of view mapped into equal linear distances in the display;

FIG. 6 is a view of a micro display showing a map with an iconic turn indicator plus words describing an upcoming turn, and a numeric speed value;

FIG. 7 is a view of a micro display showing a map with an iconic turn indicator plus words describing an upcoming turn, a numeric speed value, and an icon indicating low battery charge level for the helmet;

FIG. 8 is a view of a micro display showing a map with an iconic turn indicator plus words describing an upcoming turn, a numeric speed value, and an icon indicating low gasoline level for the vehicle; and

FIG. 9 is a view of a micro display showing a map with an iconic turn indicator plus words describing an upcoming turn, a numeric speed value, and a combined icon and number indicating transmission gear shift state for the vehicle.

### DETAILED DESCRIPTION OF THE PREFERRED EMBODIMENTS

A HUD system is described for displaying information to the user optionally incorporates several visual elements according to user control, including optionally a super-wide-angle rear facing camera view, optionally a map view in place of the rear camera view, optionally the camera view plus turn by turn travel guides, optionally the camera view plus vehicle and/or helmet telemetry, optionally the camera view plus turn by turn travel guides and telemetry. Advantageously, the HUD system directly enhances vehicle operator safety by providing increased situational awareness combined with decreased reaction time.

This HUD system is preferably used with a helmet, such as a motorcycle helmet, that functions with visor open or closed, as it incorporates a separate micro-display and optical stack with a partially silvered prism or holographic waveguide to position a small see-through display in the operator's field of view, as described herein. Other embodiments of the HUD include, but are not limited to, a windshield of a motorized or human-powered vehicle for ground or water transportation.

As also described herein, the HUD system also incorporates a digital processor to de-warp super wide-angle camera imagery, with the benefit of providing the operator coherent image distance judgments from center (directly behind) to edge (left or right side) vectors, including blind spot areas normally invisible to an operator of a vehicle equipped with standard rear and side mirrors.

Additional image processing can also be included to enhance imagery to compensate for fog or low light, and also to increase the saliency of certain image components, such as yellow traffic lines, lane markers, or other relevant objects.

Rear view camera imagery is also preferably blended digitally with navigation information (e.g., turn by turn directions) and/or vehicle telemetry (e.g., speed, tachometer, check engine, etc.) by a processor provided by such information by radio or other means, for display on the heads-up display, as described herein. Additionally, navigation, telemetry, and other information may be presented aurally to the operator.

The HUD system display is preferably focused at an ocular infinity. The benefit is that visual accommodation is negated, resulting a comprehension improvement on the part of the operator on the order of hundreds of milliseconds. In human vision, objects approximately eighteen feet or farther away do not require the eye to adjust focus; the eye's focusing is relaxed. In an ordinary vehicle, display and control elements are much closer than eighteen feet, and muscles in the eyes must pull on the lens of the eye and distort it to bring such objects into focus. This is called “visual accommodation”, and takes on the order of hundreds of milliseconds. The benefit of a display focused at infinity is that no visual accommodation is needed to look at the display and again nine is needed to look back to the road; comprehension and situational awareness is accomplished much faster, resulting in increased safety for the operator.

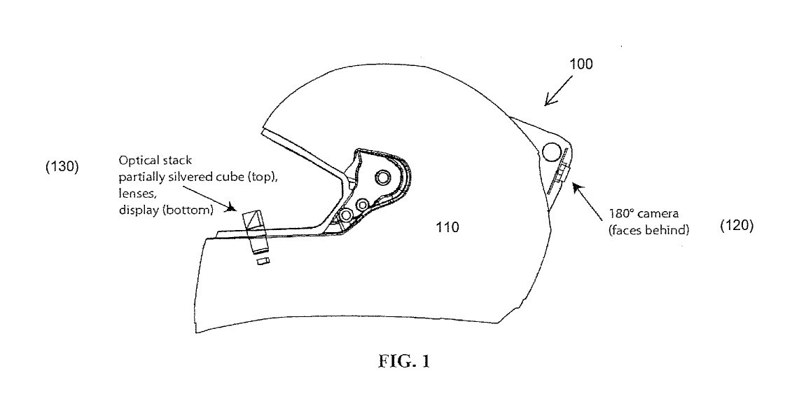

FIG. 1 illustrates one embodiment incorporating features of an embodiment of the HUD system 100 that include a helmet 110 with an integrated rear looking camera 120 and an integrated micro display 130, different embodiments of which will be described hereinafter. From FIG. 1, it is apparent that the camera 120 is mounted so as to look to the rear when being worn, and the display 130 will also present to the user when being worn.

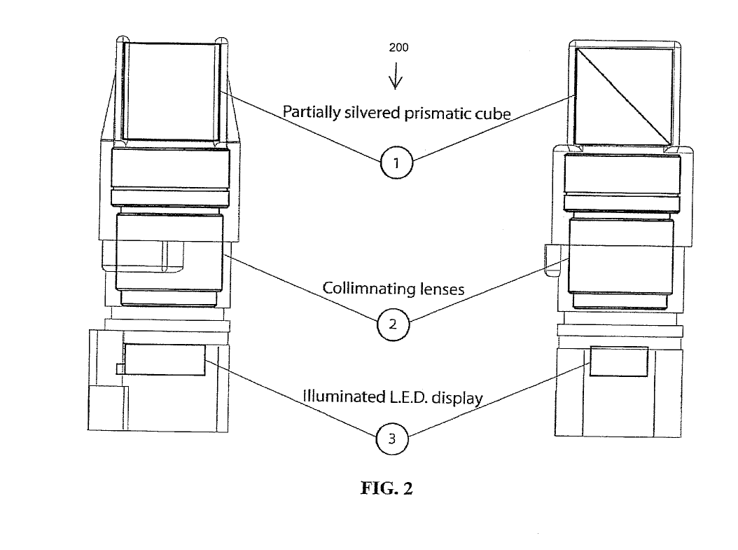

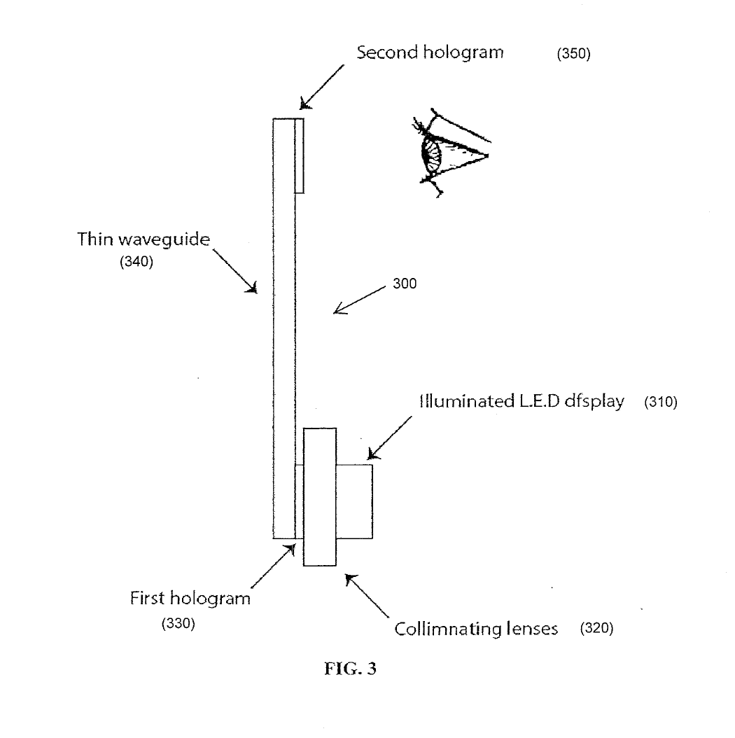

The display shown as display 130 in FIG. 1 may be accomplished by several detailed designs. FIGS. 2 and 3 detail two embodiments of compact designs.

In the first shown in FIG. 2, a vertical stacking of a micro-display 3, collimating lenses 2, and a partially reflective see-through cubical prism 1 comprise the display system 200. This is illustrated in placement and relative size in FIG. 1 as part of a complete helmet system.

In the embodiment shown in FIG. 3, a differing optical stack 300, comprised of a micro-display 310, collimating lenses 320, a first hologram 330, a thin optical waveguide 340 (which is shown as straight but can be curved), and a second hologram 350 may be substituted. This embodiment has the additional benefit of an even smaller size, and the use of a curved waveguide as opposed to the straight optical path of the first design, allowing for greater integration into the form factor of the helmet.

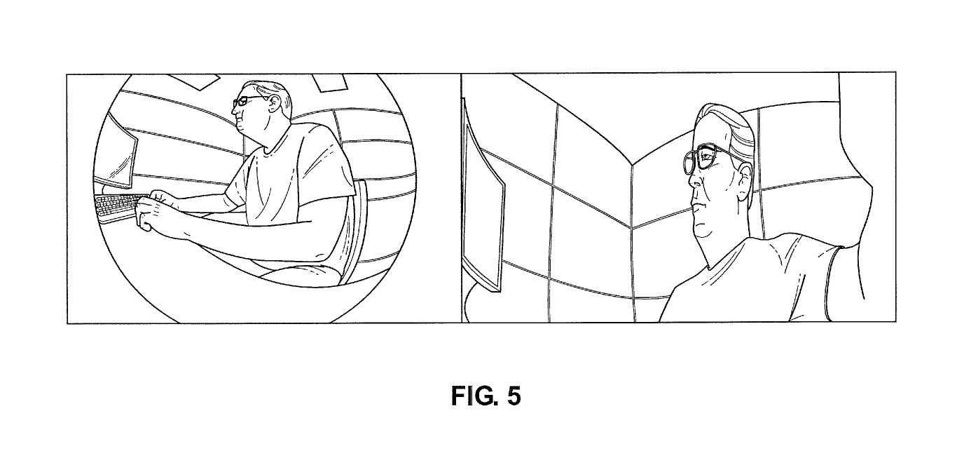

The HUD system may accomplish a digital transformation of the rear facing cameras imagery so as to dewarp the image so as to accomplish equal angles of view mapped into equal linear distances in the display e.g., the usual and traditional “fish eye” view of a 180 or 210 degree lens is transformed so that items and angles near the center are similar in size and displacement to items and angles near the edges, particularly left and right edges. This effect is shown in FIG. 5, which shows a view of a 180 degree “fish-eye” camera image (left) and a view of a dewarped image (right) which has been transformed so as to accomplish equal angles of view mapped into equal linear distances in the display. It will be apparent to one skilled in the art that this display differs from the standard warped view in rear-view mirrors where “objects are closer than they appear”, particularly near the edges.

The effect described in may be accomplished by direct digital image processing in the camera sensor itself, and subsequently displayed to the user.

The effect may be accomplished by subsequent digital image processing by an onboard digital processor in the helmet, and subsequently displayed to the user.

The effect may optionally be overlaid with a graphical indication of the true angles relative to the camera mounted in the helmet. For example, a reticule may be overlaid indicating the where true angles such as 45, 90, and 120 degree angles have been mapped into the warped/dewarped image. This can aid the user in understanding where rearward objects are relative to their head, body, and vehicle.

The various configurations of the display may be optionally enabled or defeated by the user.

The desired configuration may be accomplished by an external application communicating with the helmet's processor via wireless communication.

In a helmet embodiment, the display configuration may be accomplished by an external application communicating with the helmet's processor via wired communication.

The display configuration may be accomplished by voice command processed by a processor internal to the helmet.

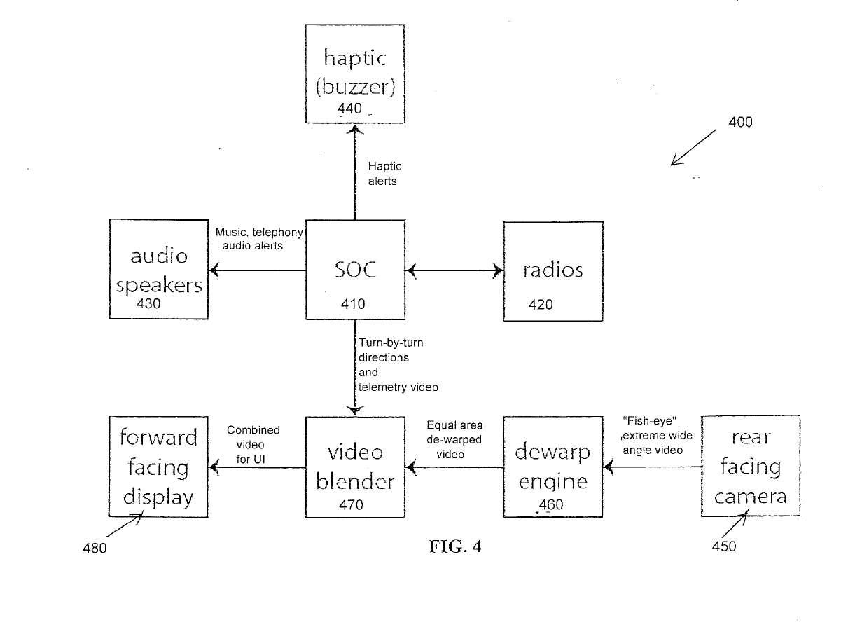

FIG. 4 is a diagram of the system 400 for the video creation, flow and combination, and display according to a preferred embodiment. As illustrated and described further herein, the system 400 in this preferred embodiment includes radio communication to other devices; also incorporating audio and haptics, with the rear facing camera and the forward facing display being also specifically illustrated in a preferred embodiment in FIG. 1. The system 400 of FIG. 4 incorporates a central System On a Chip (SOC) 410, which is preferably a highly integrated microprocessor capable of running a modern operating system such as Android 4.4, and with sufficient interface capabilities to control satellite devices, switches, and input and output audio and graphical information, along with software written to then perform the functions as described herein loaded thereon. An example is the Texas Instruments OMAP 4460 SOC, running Android 4.4 “KitKat”. This SOC 410 acts to gather information such as Global Positioning System (GPS) location data, vehicle telemetry, and map information either from internal storage and/or externally via radios 420 as described herein, and compose graphical representations that are merged with camera imagery from the rear-facing camera 450, and then presented to the operator, via the video blender 470 as described herein. Additionally, the SOC 410 may compose and present audio and haptic representations also presented to the operator via speakers 430 and buzzers shown at 440. An assortment of radios 420 may be used as input/output to the SOC 410; GPS (receive only), BlueTooth (transceiver), WiFi (transceiver) and various telephony (e.g., LTE, GSM, etc.).

In the preferred embodiment of the system, the rear-facing camera 450 collects a video stream of extreme wide-angle imagery from the rear of the helmet (or vehicle), which is processed, preferably as shown by a specialized dewarp engine 460 (or dedicated processor as described herein) to “de-warp” the imagery so as to present the appearance of objects in the center rear, and extreme left and right at equal distances from the camera 450 as being the same visual area thus same perceived distance from the operator, as opposed the conventional “fish-eye” view where objects at the same distance appear much larger in the center versus the edges of the field of view of a camera. This de-warping may be produced within a single frame time by a dedicated processor used as a dewarp engine 460, such as the GeoSemiconductor GW3200, and this is the preferred such embodiment. However, the dewarping may also be accomplished by a more general purpose processor or SOC, albeit at greater expense and/or time delay (the latter may be more than one frame time; this delay decreases appropriate operator situational awareness and increases reaction time to events). Likewise, the dewarping may be accomplished by the central SOC 410, albeit again at greater time delay that is more than one frame time.

In the preferred embodiment of the system 400, graphical representations composed by the SOC 410 are merged with camera imagery, and then presented to the operator. This may be accomplished by specialized video blending circuitry 470, which present lightens the computational load on the SOC 410, and is preferably accomplished in less than one frame time. The merging may also be accomplished by the SOC 410 itself, by the SOC 410 reading in the video imagery from the dewarp engine 460, and composing the graphical representation merged with the video in an on-chip buffer, and then writing it out to the camera display 480. However, this may require a more expensive SOC 410, and/or greater time delay than one frame time, and thus is not the preferred embodiment. One implementation that accomplishes the preferred embodiment is to use as the video blender 470 and the display 480 a Kopin A230 display that incorporates video blending circuitry. In one implementation, the video from the GeoSemiconductor GW3200 dewarp engine is output in RGB565 format (5 bits per pixel for red, 6 bits per pixel for green, five bits per pixel for blue) video, and the SOC 410 outputs its graphical imagery as RGB4444 (four bits per red, green, blue and 4 bits for a video alpha channel) which is combined by the Kopin display controller into a combined video stream that is rendered to the operator.

The HUD system can also incorporate additional digital image processing and effects to enhance, correct, subsample, and display the camera imagery.

For example, the image processor may be able to detect the horizon and adjust the imagery to keep the horizon within a preferred region and orientation of the image displayed to the user.

The image processor may be able to auto correct for environmental illumination levels to aid the user in low light conditions, by adjusting brightness, gamma, and contrast.

The image processor may be able to edge-enhance the imagery for low contrast conditions such as fog, drizzle, or rain, especially combined with low light levels, It will be apparent to one skilled in the art that digital convolutions such as Laplacian kernels may be readily applied to the imagery to accomplish such enhancement.

The image processor may be able to detect road markers such as lane lines, and enhance their appearance to increase salience to the user.

The HUD system incorporates additional digital image processing and effects to detect image elements and present audio indicators to the user corresponding to salient properties of said image elements.

For example, where a “blob” is detected by image processing or by radar/lidar and it's trajectory is mapped into a spatialized audio “earcon” that informs the user of the blobs location and movement relative to the helmet. It will be apparent to once skilled in the art that several such objects may be detected and presented to the user simultaneously.

The blob may be visually enhanced to increase its salience to the user.

The blob moving into an important and salient location relative to the user (e.g., a blind spot) is presented to the user via a haptic interface.

The haptic effector may be an integral part of the users helmet, suit, jacket, boots, or other clothing.

The coupling with the haptic interface may be accomplished wirelessly or via a wired connection.

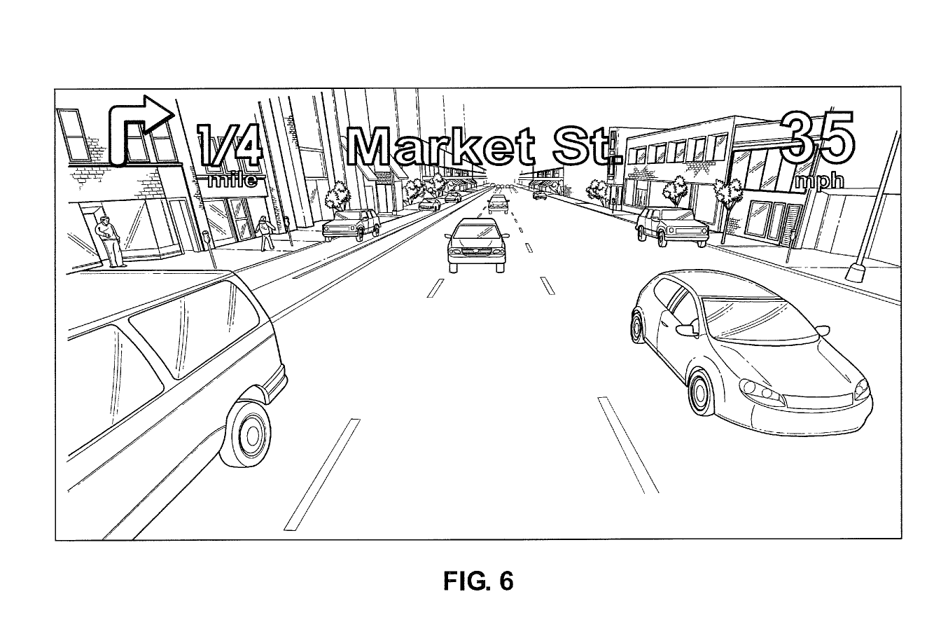

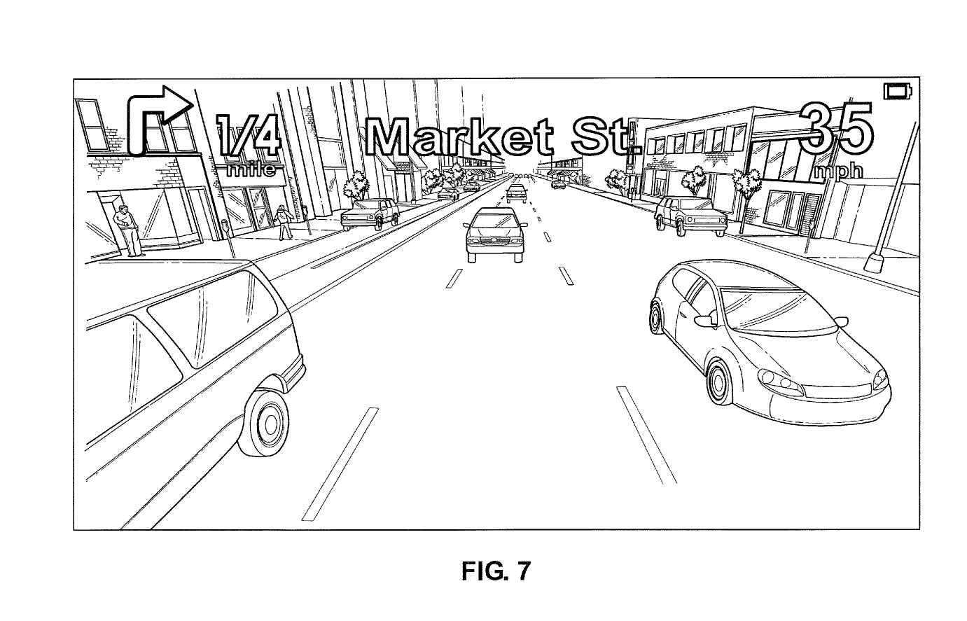

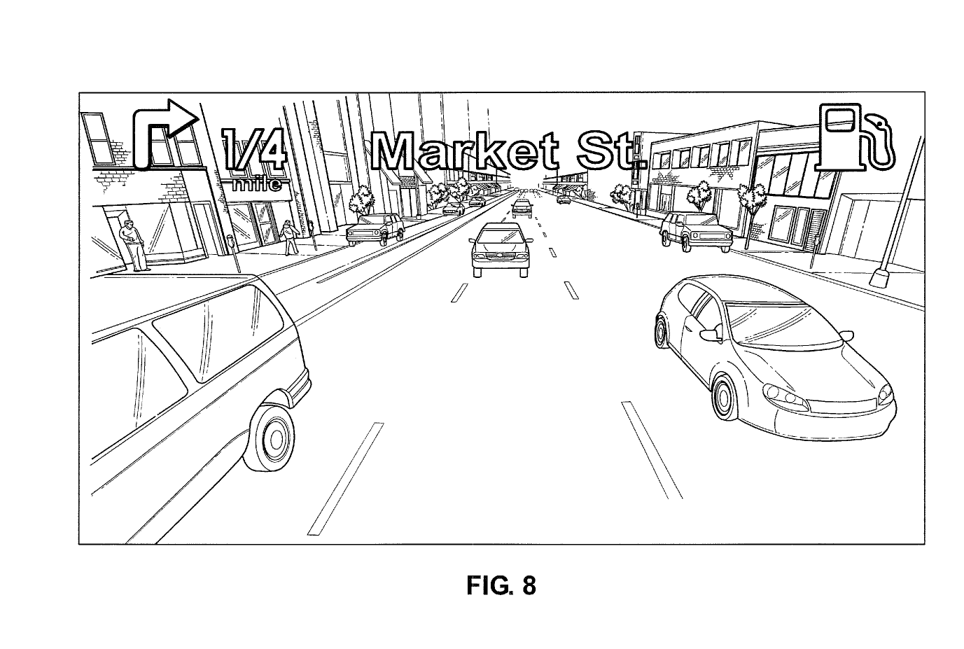

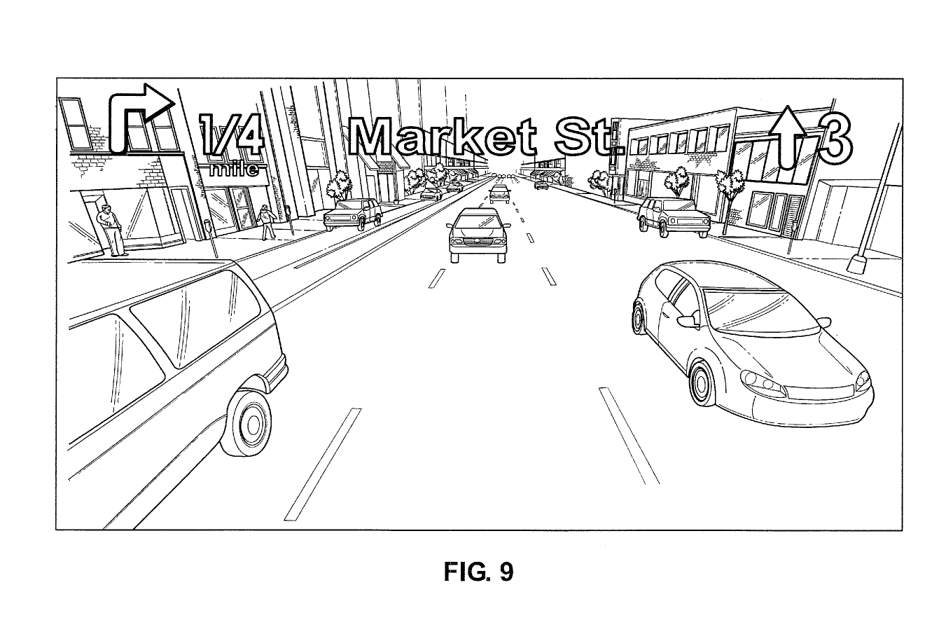

In one embodiment of the HUD system, the camera view incorporates indicators in the left or right corner informing the user of an upcoming turn, as shown in FIGS. 6-9. This is important in that it shows all relevant data for safely maneuvering toward a turn using one visual location requiring only one main saccade and no ocular accommodation, In other words, the rider sees a navigation cue, and all visual blind-spot information in one HUD screen with one glance. This substantially minimizes the time for a user to recognize and act on the information,

The indicators change color, hue, and/or brightness in a manner to indicate how soon the turn should occur. As rider approaches the turn, the HUD UI may display several dots or pixel maps which illuminate in a sliding fashion across the top of the HUD display in the direction of the turn. If it is a right turn, it will slide left. If it is a right turn, it will slide right. As the turn approaches, the animation increases in speed until it is solid-on when the driver is upon the turn. This feature essentially operates as a visual proximity sensor, When paired with voice direction this creates a very clear instruction to the operator to execute subsequent navigation.

The indicator informs the user of an approaching curve requiring slowing down, where this may be indicated by salient variations in hue, lightness, brightness, boldness, and/or blinking.

In some embodiments, textual information is displayed between the left and right turn indicator regions; e.g., “Right turn in 0.5 miles”.

Navigation information, and/or warnings may be presented aurally as tones or voice.

As mentioned before, the display and communication configuration may be selected, defeated, and/or combined under user control. E.g., the user may select rear view display only, rear view display plus voice directions, voice only, etc., in all relevant combinations.

The personalized configuration may be accomplished via an app on an external device.

The configuration may be communicated wirelessly or through a wired connection.

In a helmet embodiment, voice command from the user may be processed by the processor integrated within the helmet.

In an embodiment where a map view or turn by turn navigation directions are selected for display, the view may be provided by an external device (such as a smart phone) connected to a digital network in real time (e.g., Google maps).

In an embodiment where or turn by turn navigation directions are selected for display, the view may be provided by an external device (such as a smart phone) with a local store of map information to be used when a digital wireless cellular connection is not available.

The map or turn by turn navigation view may also be provided by a local digital storage (such as a memory module within a helmet) as a backup to the map or turn by turn navigation information retrieved from the external device, for use when a digital wireless cellular connection is not available

The map or navigation view described may be controlled and initialized by an app on an external device (such as a smartphone) via wired or wireless connections.

The present disclosure also relates to additional presentation aspects, in addition to the video imagery, additional graphical presentations overlaid on the video that correspond to vehicle telemetry information, such as but not limited to speed, tachometer, temperature, check engine, and fuel supply.

The present disclosure also relates to the presentation, in addition to the video imagery and graphical imagery, audio alerts (tones and voice) that correspond to and augment the visual presentation.

The present disclosure also relates to the presentation, in addition to the video imagery and graphical imagery, audio such as music both stored internally and on an external device, and the provision of two way radio communication to accomplish telephony and “walky-talky” conversation.

The present disclosure also relates to the presentation, in addition to the video imagery, graphical imagery, and audio, haptic stimulation (e.g., buzzer, tactile pressure, etc.) that corresponds and augments the other alerts.

The present disclosure also relates to the presentation, in addition to the video imagery, graphical imagery, and audio, haptic stimulation (e.g., buzzer, tactile pressure, etc.) that corresponds and augments the other alerts.

Although the embodiments have been particularly described with reference to embodiments thereof, it should be readily apparent to those of ordinary skill in the art that various changes, modifications and substitutes are intended within the form and details thereof, without departing from the spirit and scope thereof. Accordingly, it will be appreciated that in numerous instances some features will be employed without a corresponding use of other features. Further, those skilled in the art will understand that variations can be made in the number and arrangement of components illustrated in the above figures.

1. An apparatus for enhancing situational awareness of a user that is moving in a forward direction, the apparatus comprising:
a rear view pointing camera that obtains a rear view video feed as the user is moving in the forward direction, the rear view pointing camera including wide-angle image capturing optics;
at least one processor coupled to the rear view pointing camera adapted to blend the rear view video feed with another video stream to obtain a blended video stream that provides for enhanced situational awareness regarding the user's immediate surrounding and upcoming surrounding, including navigation information related to forward travel of the user; and
a display that includes a semi-transmissive screen mounted to a surface to provide the blended video stream onto the semi-transmissive screen facing the user when the user is looking in the forward direction, wherein the display is further mounted to the surface to provide an unobstructed forward view to the user when the user is looking in the forward direction.

2. The apparatus of claim 1, wherein wide-angle image capturing optics captures rear-view video image from an angular field of rear-view between 160° and 210° including blind spots.

3. The apparatus of claim 1, wherein the at least one processor also adjusts warping of elements of the rear-view video feed to avoid image distortion in the blended video stream displayed on the semi-transmissive screen of the display.

4. The apparatus of claim 3, wherein the warping is adjusted by the processor such that elements at equal angular view in captured raw rear-view video images are mapped at equal apparent linear distance in the blended video stream displayed on the semi-transmissive screen of the display.

5. The apparatus of claim 1, wherein the navigation information related to forward travel of the user includes one or more of: an indication of a direction of an upcoming turn, and an indication of a distance of the upcoming turn, upcoming hazards, stops, points of interest, or destination.

6. The apparatus of claim 5, wherein the navigation information further includes a visual cue for comprehension of changing relative distance and direction of an upcoming turn.

7. The apparatus of claim 6, wherein the visual cue comprises a series of visual proximity sensor pixel maps changing one or more of their shape, size, color, hue, brightness, and rate of pulsation, corresponding to the changing relative distance and direction of the upcoming turn.

8. The apparatus of claim 1, wherein the navigation information comprises a map view.

9. The apparatus of claim 8, wherein the user is enabled to superimpose the map view covering a portion or an entirety of the processed rear-view video image displayed on the semi-transmissive screen.

10. The apparatus of claim 8, wherein the navigation information comprises a display of an indication of a distance and direction of an upcoming turn, and a visual proximity sensor providing a visual cue for comprehension of changing relative distance and direction of the upcoming turn overlaid on the map view.

11. The apparatus of claim 1, wherein the processor is further configured to add visual effects to the display indicating at least one of weather conditions and traffic conditions.

12. The apparatus of claim 1, wherein the display is focused at an ocular infinity of the user.

13. The apparatus of claim 1, wherein the processor is further configured to add visual effects to the display indicating vehicle telemetry including a plurality of speed, transmission status, tachometer, gasoline level, and check engine.

14. The apparatus of claim 1, wherein the processor is further configured to add visual effects to the display indicating helmet status, including battery level.

15. The apparatus of claim 1, wherein the processor is further configured to enhance the rear-view video image by confining the visual horizon within a predetermined area of the display.

16. The apparatus of claim 1, wherein the processor is further configured to enhance the rear-view video image by detecting low contrast viewing conditions including fog, and processing the video to adjust gamma, brightness and darkness, and enhance edges to increase salient visibility.

17. The apparatus of claim 1, wherein the processor is further configured to enhance the rear-view video image by modifying the hue, saturation and/or brightness of certain pixel ranges in order to increase the saliency of objects such as yellow lane markers and traffic lights.

18. The apparatus of claim 1, wherein the processor is further configured to enhance the rear-view video image by combining information from an attached radar or lidar unit that provides range and relative velocity information, allowing regions of the video imagery to be increased in visual saliency by outlining, blinking, increased contrast or hue, lightness, and/or saturation or other visual means of drawing attention to rapidly approaching objects.

19. The apparatus of claim 1, wherein the processor is coupled to a gyroscope such that the rear-view video image is displayed at a preferred orientation for the user.

20. The apparatus of claim 1, further including a microphone coupled to the at least one processor to communicate voice commands from the user to indicate and control a preferred configuration of the display.

21. The apparatus of claim 1, further including a speaker coupled to the at least one processor to provide audio indications correlated to the navigation information.

22. The apparatus of claim 1, further including a haptic interface device coupled to the at least one processor to provide haptic feedback correlated to the navigation information.

23. The apparatus of claim 22, wherein the haptic interface device is integrated with clothing or accessory that the user is wearing on his person.

24. The apparatus of claim 1, wherein the semi-transmissive screen is part of a helmet, disposed inside s face shield thereof, the processor is integrated to the helmet and the rear view pointing camera is mounted at a back of the helmet.

25. The apparatus of claim 1, wherein the semi-transmissive screen is part of a motor vehicle's windshield, and the processor and rear view pointing camera are mounted on the motor vehicle.

26. An apparatus for enhancing situational awareness of a user that is moving in a forward direction, the apparatus comprising:
a rear view pointing camera that obtains a rear view video feed as the user is moving in the forward direction, the rear view pointing camera including wide-angle image capturing optics;
at least one processor coupled to the rear view pointing camera adapted to process the rear view video feed and thereby provide for enhanced situational awareness regarding the user's immediate surrounding; and
a display that includes a semi-transmissive screen mounted to a surface to provide the rear view video stream onto the semi-transmissive screen facing the user when the user is looking in the forward direction, wherein the display is further mounted to the surface to provide an unobstructed forward view to the user when the user is looking in the forward direction, the display being focused at an ocular infinity of the user, wherein the display is configurable by the user.
